(19) United States
(12) Patent Application Publication
(10) Pub. No.: US 2009/0173195 A1
(43) Pub. Date: Jul. 9, 2009

(54) ADJUSTABLE WOOD LATHE

(76) Inventor: Jack Yang, Fengyuan City (TW)

Correspondence Address: APEX JURIS, PLLC, 12733 LAKE CITY WAY NORTHEAST, SEATTLE, WA, 98125, US

(21) Appl. No.: 11/969,442

(22) Filed: Jan. 4, 2008

(51) Int. Cl. B27C 7/00; B23B 3/00; B27C 7/02

(52) U.S. Cl. 82/117; 142/1

(57) ABSTRACT

An adjustable wood lathe includes a platform which has two ends holding respectively a head and a tail seat and also holds a cutter dock in the middle. The head and the platform may be spaced from each other by wedging a plurality of pallets of different thickness between them. The platform and the tail seat also may be spaced from each other by wedging a plurality of pads of different thickness between them. The cutter dock has the top portion couplable with sleeves of different lengths. Thus the cutter rack located on the cutter dock is movable to adjust the elevation corresponding to a working piece to do cutting operation. By increasing the distance of the platform and the center line of the head and tail seat operation range can be flexibly adjusted to do cutting operation of different working pieces.

### FIELD OF THE INVENTION

The present invention relates to a wood lathe and particularly to a structure that can flexibly adjust the elevation of the center line of a head and a tail seat from a platform of the wood lathe.

### BACKGROUND OF THE INVENTION

A conventional wood lathe, referring to FIG. 1, generally has a platform 1, a head 2 at one end of the top portion that has one end to generate rotation through a motor and a pulley (not shown in the drawing) and another end with a head mandrel 3 located thereon, and a tail seat 4 located at another end of the platform 1 with a tail mandrel 5 located thereon opposing the head 2. The head mandrel 3 and the tail mandrel 5 are positioned on straight line to jointly clamp a rod type working piece to rotate between them. There is a cutter rack 6 in the middle of the platform 1 that allows user's hands to straddle thereon reciprocally left and right so that a cutter held by the hands can perform cutting operation on the working piece to form curves of different diameters and lengths on the surface of the working piece. The elevation of the head 2 and tail seat 4 cannot be altered. Hence the diameter of the working piece is limited to a selected range. If the diameter of the working piece is too large, it will hit wooden chips accumulated on the platform 1. Hence the wooden chips have to be cleared frequently. Due to the conventional wood lathe has a limited working range its application also is restricted and cannot handle the working piece of a greater size.

### SUMMARY OF THE INVENTION

Therefore the primary object of the present invention is to provide an adjustable wood lathe that includes a platform which has an axial dovetail trough in the middle, a head fastened to a head end of the dovetail trough and a tail seat fastened to a tail end of the dovetail trough. There is also a L-shaped cutter dock located in a middle portion of the platform. The head has a bottom which can be spaced from the platform by wedging a plurality of pallets of different thickness between them. The tail seat also can be spaced from the platform by wedging a plurality of pads between them. The cutter dock has a duct at the top to be coupled with a first sleeve or a second sleeve of different lengths so that a cutter rack located at an upper side of the cutter dock can be adjusted at varying elevation to allow user's hands straddle thereon to perform cutting operation on a working piece. By means of the construction set forth above the elevation of the center line between the head and tail seat can be increased to do cutting operation of the working piece of varying diameters to prevent the working piece from hitting the wooden chips accumulated on the platform.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional wood lathe.

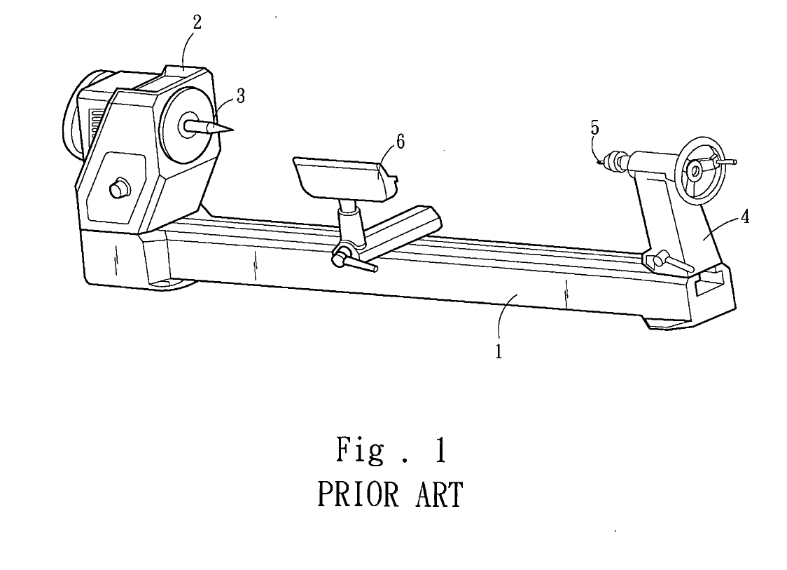

FIG. 2 is an exploded view of an embodiment of the invention.

FIG. 3 is a perspective view of another embodiment of the invention with a first and second pallets and a first pad in an assembled condition.

FIG. 4 is a perspective view of yet another embodiment of the invention with a first, second and third pallets and a first and second pads in an assembled condition.

### DETAILED DESCRIPTION OF THE PREFERRED EMBODIMENTS

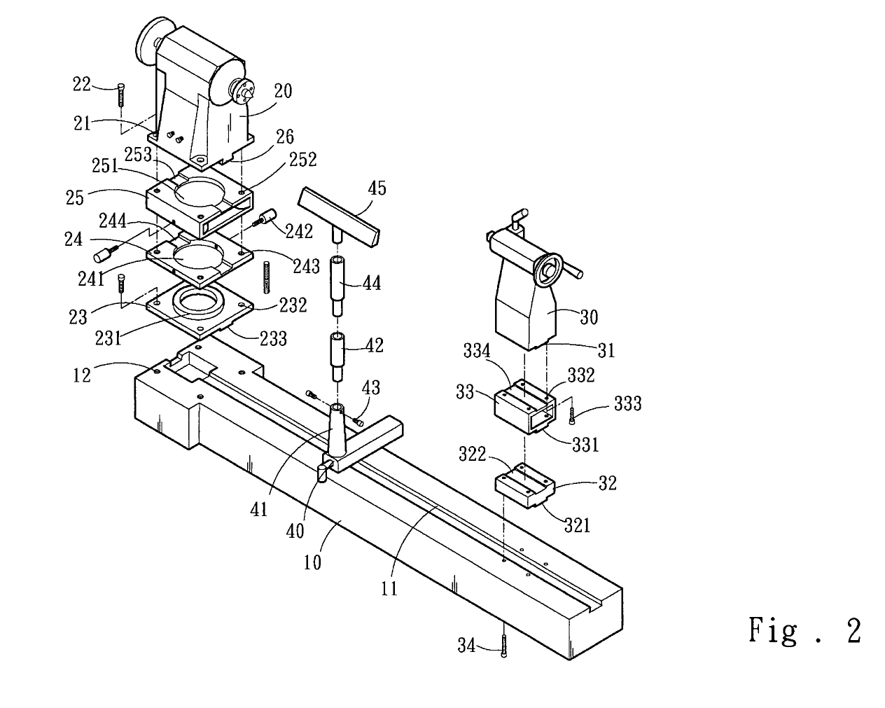

Please refer to FIG. 2, the adjustable wood lathe according to the invention includes:

an elongate platform 10 which has an axial dovetail trough 11 formed at the top thereof and four bores 12 formed on a head end thereof;

a head 20 which straddles a head end of the dovetail trough 11 and has an axial head mandrel in the center and an aperture 21 formed at each of four corners of the bottom thereof to be run through by a bolt 22 to be fastened to the bore 12 of the platform 10. The head 20 further has a latch ridge 26 at the bottom formed in a shape mating the dovetail trough 11 so that the latch ridge can be slid from one side of the platform 10 and fastened thereon;

a first pallet 23, a second pallet 24 and a third pallet 25 that are mating the profile of the bottom of the head 20. The third pallet 25 has a thickness greater than the first and second pallets 23 and 24, and is hollow. The first pallet 23 has a jutting retaining ring 231 in the middle of the top portion thereof and a fisheye opening 232 at each of four corners thereof to allow the bolt 22 to run through from the upper side to the lower side to fasten the first pallet 23 to the bore 12 of the platform 10. The first pallet 23 further has a first latch member 233 at the bottom to wedge in the dovetail trough 11 from one side. The second pallet 24 has a second coupling opening 241 in the center to be coupled on the periphery of the retaining ring 231 of the first pallet 23. The second pallet 24 can be fastened to the retaining ring 231 by screwing a screw 242 from an outer side with a distal end thereof pressing an outer wall of the retaining ring 231. The second pallet 24 also has a screw hole 243 at each of four corners thereof, and a second dovetail trough 244 in the middle of the top surface to be coupled with the latch ridge 26 of the head 20. The third pallet 25 has a third coupling opening 251 running through up and down in the center and a screw hole 252 at each of four corners thereof to receive the bolt 22, and a third dovetail trough 253 at the top portion thereof to be wedged in by the latch ridge 26 of the head 20;

a tail seat 30 which has an axial tail mandrel opposing the head mandrel and a jutting rail 31 at the bottom corresponding the dovetail trough 11 to be wedged in from the tail side of the platform 10 for anchoring thereon;

a first pad 32 with a first rail 321 at the bottom to be wedged in the dovetail trough 11 from one side. The first pad 32 has a first sliding trough 322 at the top and four corners to receive respectively a bolt 34 upwards to run through the bottom of the platform 10 and the first pad 32 to be fastened to the surface of the platform 10;

a second pad 33 which is hollow from a front side through a rear side, and formed at a thickness greater than the first pad 32. The third pad 33 has a second rail 331 at the bottom mating the dovetail 11 of the platform 10 and is fastened to the platform 10 through the four bolts 34 from the bottom of the platform 10 to the top surface thereof. The second pad 33 has through holes 332 at the four corners of the top side each engages with a bolt 333 running through the second pad 33 upwards to be fastened to the bottom of the tail seat 30 so that the second pad 33 and the tail seat 30 are bonded together. The second pad 33 further has a second sliding trough 334 at the top portion to be coupled with the jutting rail 31 of the tail seat 30;

a cutter dock 40 which is formed in a L-shape and located between the head 20 and tail seat 30 with a horizontal bottom wedging in the dovetail trough 11 of the platform 10, and has a duct 41 at the top;

a first sleeve 42 which has the bottom formed at a diameter smaller than the top thereof. The bottom is couplable with the duct 41 and fastened thereon through a screw 43 from an outer side of the duct 41 with a distal end of the screw 43 pressing an outer wall at the bottom of the first sleeve 42 to fasten the first sleeve 42 to the duct 41;

a second sleeve 44 formed at a length greater than the first sleeve 42 and a bottom at a diameter smaller than the top thereof such that the bottom is insertable in the duct 41 and also is fastened through the screw 43; and

a cutter rack 45 which has the bottom insertable into the duct 41 or engageable with the top of the first sleeve 42 or the second sleeve 44. The cutter rack 45 has an axial top portion relative to the platform 10 to allow user's hands to straddle thereon.

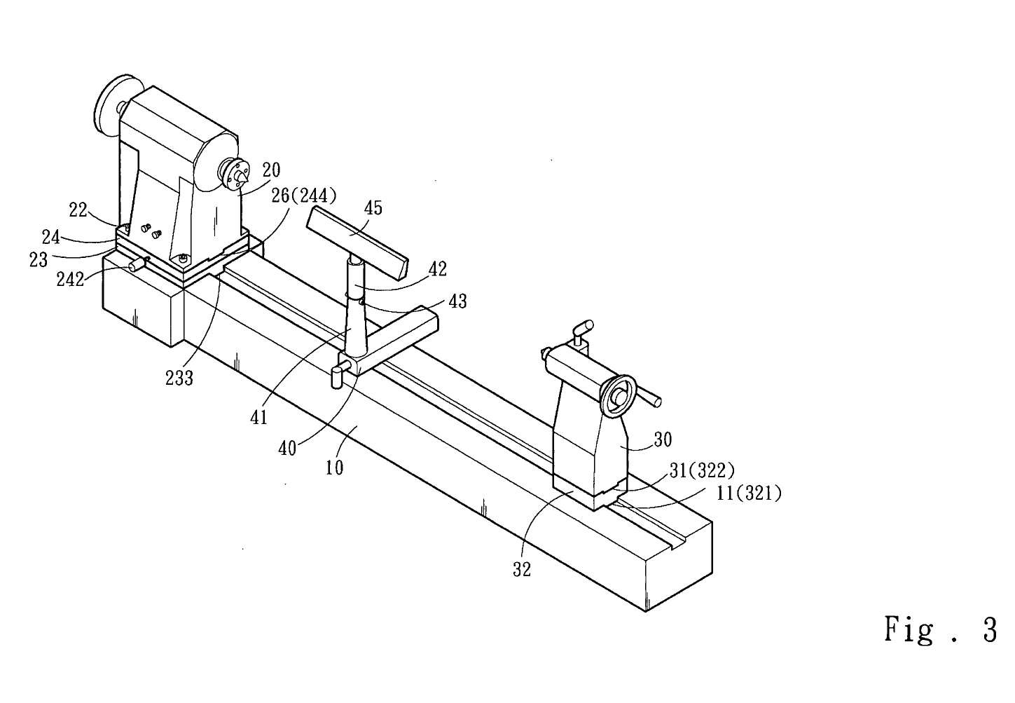

By means of the construction set forth above, when in use and the size of a working piece is greater than an allowable range, the head 20 can be raised at a higher elevation by fastening the first pallet 23 to the top of the platform 10, or further stacking the second pallet 24 at the top portion of the first pallet 23 as shown in FIG. 3 with the head 20 straddling the top surface of the second pallet 24. Then the head 20 can be fastened to the platform 10 by screwing the four bolts 22 through the apertures 21 downwards through the second pallet 24. Hence the distance between the head 20 and the top surface of the platform 10 can be increased. The first pad 32 also may be fastened to the tail end of the platform 10 to increase the distance of the tail seat 30 and the platform 10 so that the tail mandrel of the tail seat 30 and the head mandrel of the head 20 can be positioned at the same horizontal line to prevent the working piece from hitting wooden chips accumulated on the surface of the platform 10.

With the center line of the head 20 and the tail seat 30 is raised at a higher elevation, user's hands straddling on the cutter rack 45 also have to be positioned higher. To accomplish this, the first sleeve 42 may be selected to couple with the duct 41, and the cutter rack 45 is inserted in the first sleeve 42.

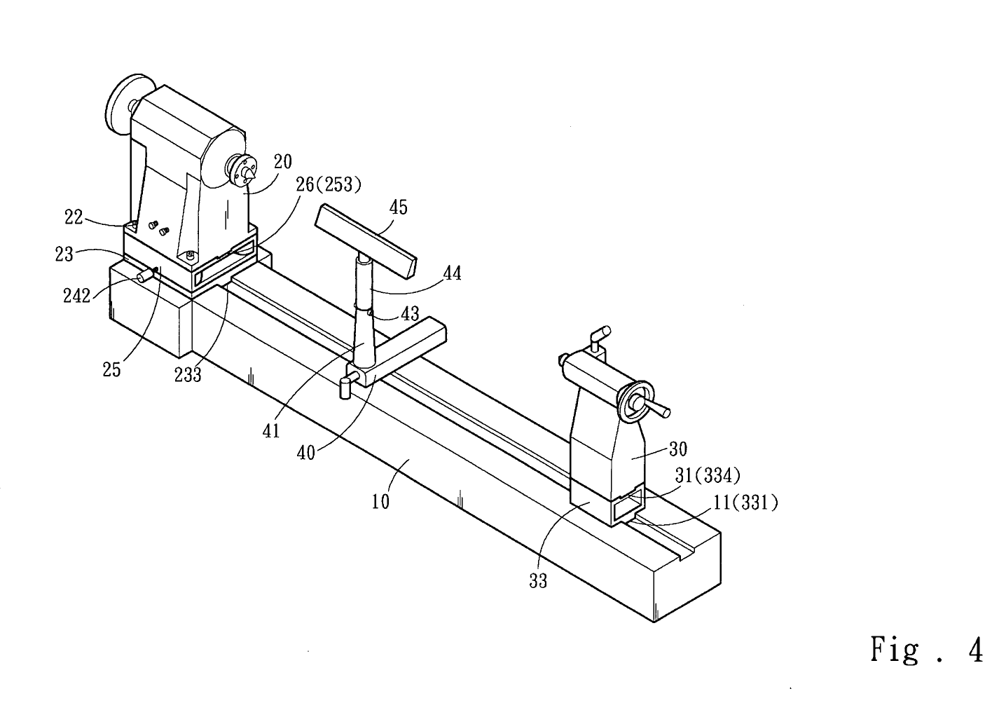

The third pallet 25 may also be stacked on the first pallet 23 as shown in FIG. 4 with the retaining ring 231 of the first pallet 23 running through the third coupling opening 251 of the third pallet 25 so that a fine tuning can be made to match the working piece.

The tail seat 30 can be raised even higher by fastening the second pad 33 to the platform 10 with the second sliding trough 334 coupling with the jutting rail 31, while the duct 41 of the cutter dock 40 is coupled with the longer second sleeve 44. Then the cutter held by user's hands can be positioned horizontally against the center line of the working piece to do cutting operation.

Of course the first, second and third pallets 23, 24 and 25 also may be stacked over one another to allow the head 20 to be fastened to the top surface of the third pallet 25. And the first and second pads 32 and 33 may also be stacked over each other and fastened to the lower side of the tail seat 30, while the second sleeve 44 can be coupled on the first sleeve 42 with the duct 41 of the cutter dock 45 mounting thereon to further raise the elevation thereof to do cutting operating for the working piece of a greater diameter.

It is to be noted that the head 20 can be fastened inversely to the first pallet 23, or second pallet 24 or third pallet 25. The head mandrel of the head 20 may be replaced by a chuck (not shown in the drawings) to clamp the working piece of a greater size without being constrained by the surface elevation of the platform 10.

As a conclusion, the invention can adjust the distance of the platform 10 and the center line of the head 20 and tail seat 30 according to requirements in response to a greater working piece which exceeds the original diameter setting of the wood lathe. Thus the working piece can be cut as desired without hitting the wooden chips accumulated on the top surface of the platform 10. User operation also is smoother and easier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An adjustable wood lathe, comprising:
a platform having an axial dovetail trough at the top;
a head having a latch ridge at the bottom thereof to be wedged in the dovetail trough;
a first pallet having a first latch member at the bottom thereof to be wedged in the dovetail trough to hold the head thereon;
a tail seat having a jutting rail at the bottom thereof to be wedged in the dovetail trough;
a first pad having a first rail at the bottom thereof to be wedge in the dovetail trough and the top to hold the tail seat; and
a cutter dock having the bottom thereof wedged in the dovetail trough and the top to hold a duct in an upright manner to hold a cutter rack which allows user's hands to straddle thereon.

2. The wood lathe of claim 1 further having a second pallet couplable with the top of the first pallet, the second pallet having a top portion to hold the head.

3. The wood lathe of claim 2, wherein the second pallet has a second dovetail trough formed at the top portion to be wedged in by the latch ridge of the head, the first pallet having a jutting retaining ring formed in the center of the top thereof, the second pallet having a second coupling opening in the center to couple on the periphery of the retaining ring and a peripheral side fastened by a screw which has a distal end pressing an outer wall of the retaining ring, the head having four corners at the bottom each being run through by a bolt to fasten to the second pallet.

4. The wood lathe of claim 2, wherein the second pallet has a top surface to couple with a third pallet which has a top side to hold the head.

5. The wood lathe of claim 4, wherein the third pallet is formed at a thickness greater than the second pallet and hollow inside from a front end to a rear end, has a third dovetail trough at the top portion thereof to be wedged in by the latch ridge of the head, the head having four corners each being run through by a bolt to fasten to the third pallet.

6. The wood lathe of claim 1 further having a third pallet coupling on the top of the first pallet, the third pallet having a top portion to hold the head and being formed at a thickness greater than the first pallet and having a third dovetail trough at the top portion to be wedged in by the latch ridge of the head, the head having four corners each being run through by a bolt to fasten to the third pallet.

7. The wood lathe of claim 6, wherein the third pallet is hollow inside from a front end to a rear end and has a third coupling opening in the center running through up and down to be coupled on the retaining ring of the first pallet.

8. The wood lathe of claim 1, wherein the first pallet is fastened to the platform through a plurality of bolts.

9. The wood lathe of claim 1, wherein the first pad has a first sliding trough formed at the top to be wedged in by the jutting rail of the tail seat and is fastened to the bottom of the platform through four bolts directing upwards from a lower side.

10. The wood lathe of claim 9 further having a second pad coupling on the first pad, the second pad having a thickness greater than the first pad and a second rail at the bottom to wedge in the first sliding trough of the first pad and a second sliding trough formed at the top thereof to be wedged in by the jutting rail of the tail seat, and four corners each being run through by a bolt to fasten to the tail seat.

11. The wood lathe of claim 1, wherein the tail seat has a top surface to hold a second pad which is formed at a thickness greater than the first pad and has a second rail at the bottom thereof to be wedged in the dovetail trough of the platform and a top to couple with the tail seat.

12. The wood lathe of claim 11, wherein the second pad has a second sliding trough at the top to be wedged in by the jutting rail of the tail seat and four corners each being run through by a bolt to fasten to the tail seat.

13. The wood lathe of claim 12, wherein the second pad is hollow inside from a front end to a rear end, the bolt being directed upwards to run through the second pad to fasten to the tail seat.

14. The wood lathe of claim 1, wherein the cutter dockis formed in a L-shape and has a horizontal bottom to be wedged in the dovetail trough, the duct being coupled with the bottom of a first sleeve that has a diameter smaller than the top thereof, the top of the first sleeve being couplable with the bottom of the cutter rack.

15. The wood lathe of claim 14 further having a second sleeve couplable with the top of the first sleeve, the second sleeve having the bottom formed at a diameter smaller than the top thereof to be coupled with the top of the first sleeve, the top of the second sleeve being couplable with the bottom of the cutter rack.

16. The wood lathe of claim 14 further having a second sleeve couplable with the top of the duct, the second sleeve being formed at a length greater than the first sleeve and having the bottom formed at a diameter smaller than the top thereof to be coupled with the top of the duct, the top of the second sleeve being couplable with the bottom of the cutter rack.
